(19) United States
(12) Patent Application Publication
(10) Pub. No.: US 2026/0211429 A1
(43) Pub. Date: Jul. 23, 2026

(54) Vehicle control method with improved collision prevention safety

(71) Applicant: SAFRAN ELECTRONICS & DEFENSE, PARIS (FR)

(72) Inventor: Philippe FEYEL, MOISSY-CRAMAYEL (FR)

(21) Appl. No.: 19/136,801

(22) PCT Filed: Dec. 8, 2022
(86) PCT No.: PCT/IB2022/000807

§ 371 Date: Jun. 6, 2025

(51) Int. Cl. G05D 1/695; H04W 4/46

(52) U.S. Cl. CPC G05D 1/695; H04W 4/46

(57) ABSTRACT

Method for controlling at least one vehicle including a propulsion system, motorised directional control members and a computer control unit connected to the motorised directional control members in order to control said members and guide the vehicle along a reference course, on the basis of a speed correction (in order to maintain a first minimum distance between the vehicle and any obstacle along the reference course) transformed into a position correction. The position correction is estimated over a prediction horizon in order to determine a course to be followed over the prediction horizon. The commands are determined so as to follow the course to be followed by applying an avoidance constraint corresponding to a second minimum distance between the vehicle and any obstacle along the course to be followed over the prediction horizon, the second minimum distance being shorter than the first minimum distance.

The present invention relates to the field of automatic control of at least one vehicle.

### BACKGROUND OF THE INVENTION

It is common for drones to be controlled such that they fly in groups along a pre-determined course. The implementation of the so-called “potential field” control algorithm makes it possible to control the drones so that they maintain gaps between them in order to impose a pre-determined geometric shape on the group while following the pre-determined course (this is referred to as geometric formation flight). This algorithm is described in the document by Erik de Vries and Kamesh Subbarao, “Cooperative Control of Swarms of Unmanned Aerial Vehicles”, 49th AIAA Aerospace Sciences Meeting including the New Horizons Forum and Aerospace Exposition, 4-7 Jan. 2011, Orlando, Florida.

Nevertheless, the implementation of such an algorithm means that, for each drone in the group of drones, there is a relatively high risk of collision with an obstacle, whether another drone (belonging to the group or not) or an element of the terrain flown over.

### AIM OF THE INVENTION

The invention aims, in particular, to be able to control at least one vehicle in a simple way while minimising the risk of collision with an obstacle.

### SUMMARY OF THE INVENTION

To this end, according to the invention, a method is provided, for controlling at least one vehicle comprising a propulsion system, motorised directional control members and a computer control unit connected to the motorised directional control members in order to control said members and guide the vehicle along a reference course, comprising the following steps:
determining speed correction in order to maintain a first minimum distance between the vehicle and any obstacle along the reference course;
transforming the speed correction into a position correction and estimating the position correction over a prediction horizon to determine a course to be followed over the prediction horizon;
determining controls to be applied to the propulsion system and to the motorised directional control members over the prediction horizon in order to follow the course to be followed by applying an avoidance constraint corresponding to a second minimum distance between the vehicle and any obstacle along the course to be followed over the prediction horizon, the second minimum distance being less than the first minimum distance and the avoidance constraint being applied when it is predicted that the vehicle and the obstacle are separated by a distance less than the second minimum distance.

An obstacle may be a fixed obstacle such as a relief element, or a mobile obstacle such as another vehicle. Said other vehicle may or may not belong to a group to which the controlled vehicle would belong. The vehicle follows the reference course (that is obtained, for example, from a predicted course generated at an instant immediately prior to a current instant), whereas the prediction of the distance between the vehicle and the obstacle is performed from a predicted course generated at the current instant (i.e., the course to be followed) and that will then serve as a reference course after the avoidance constraint is applied, or not. Thus, the method of the invention allows relatively simple control in a nominal mode in which the obstacles are relatively far from the controlled vehicle and more generated predictive control imposing a hard avoidance constraint when the obstacles are closer to the controlled vehicle. It is understood that control in nominal mode is freer and optimised in terms of following the pre-determined course. The control in nominal mode thus consumes less computational resources than the predictive command with avoidance constraint. The method of the invention amounts to superimposing, if necessary, a safety over-layer on a nominal control. This limits the risk of collision, while ensuring that the pre-determined course is followed as closely as possible.

According to a preferred embodiment, the speed correction is determined by using the potential field algorithm and the controls under avoidance constraints are determined by using a method of constrained non-linear model predictive control.

The invention thus enables a coupling between the potential field algorithm and a constrained non-linear model predictive control. When the method of the invention is used for controlling a plurality of vehicles along the reference course, the potential field algorithm corrects the reference course to be followed by each vehicle in such a way that the vehicles asymptotically form the geometric formation defined by the potential field algorithm. This formation is characterised, among other things, by a required asymptotic distance between vehicles and obstacles. Constrained predictive control imposes a strict minimum safety distance between vehicles and obstacles (the second minimum distance is a safety distance that is less than the first minimum distance that is characteristic of the geometric formation defined by the potential field algorithm). The method of the invention thus creates an algorithm of safe potential fields in the sense that this guarantees a minimum distance.

Other features and advantages of the invention will appear on reading the description below of a particular and non-limiting embodiment of the invention.

### BRIEF DESCRIPTION OF THE DRAWINGS

Reference will be made to the accompanying drawings, in which:

FIG. 1 is a diagrammatic view of a vehicle for implementing the method in accordance with the invention;

FIG. 2 is a diagrammatic view of a group of vehicles moving along a course to be followed in accordance with the method of the invention;

FIG. 3 is a block diagram of showing the implementation of the method of the invention.

### DETAILED DESCRIPTION OF THE INVENTION

In this case, the invention is described in relation to the control of a plurality of aeronautical drones, called agents, flying in groups or swarms according to a pre-determined geometric configuration (also referred to as flight in geometric formation). It will be noted that, in the preceding part of the description, “obstacle” equally designates another agent of the group of agents or an obstacle external to the group of agents, whereas, in the following part of the description, “obstacle” exclusively designates an obstacle external to the group of agents, this obstacle possibly being mobile or immobile.

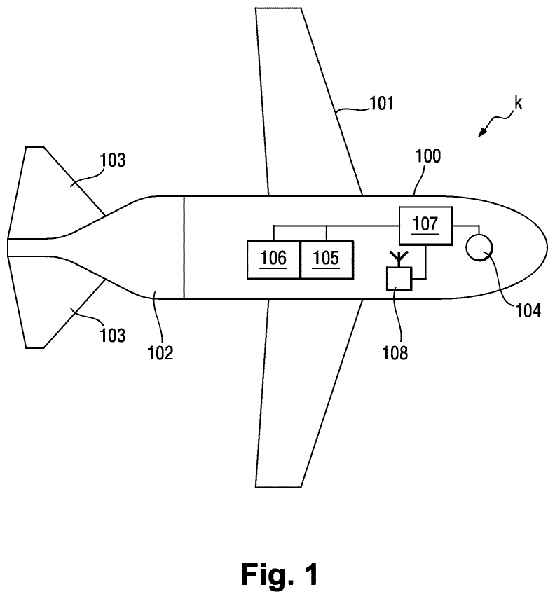

With reference to FIG. 1, each agent k comprises a structure 100 that is equipped with a fixed aerofoil 101 (in a variant, the aerofoil may be rotary) and in which the following are mounted:
a propulsion system 102 such as a propeller motor or a turbojet;
motorised directional control members 103 such as mobile control surfaces equipped with electromechanical actuators;
at least one obstacle sensor 104 detecting obstacles in the vicinity of the agent k, the obstacle sensor being, for example, a radar providing 360° surveillance around the agent k and providing the position of each obstacle detected;
an inertial measurement unit 105;
a receiver 106 of satellite positioning signals (or GNSS signals);
a computer control unit 107 connected to the propulsion system 102, to the motorised directional control members 103, to the sensor 104, to the inertial measurement unit 105 and to the receiver 106.

The computer control unit 107 conventionally comprises one or more processors and a memory containing at least one computer program that can be executed by the one or more processors and that implements the control method of the invention.

The computer control unit 107 is connected to the sensor 104, to the inertial measurement unit 105 and to the receiver 106 in order to receive from said members, information in the form of data signals. The computer control unit 107 is connected to the propulsion system 102 and to the motorised directional control members 103 in order to control said members by means of control signals generated as a function of the information received. The computer control unit 107 also receives, from the propulsion system 102 and the motorised directional control members 103, data signals representative of an operating state of the propulsion system 102 and the motorised directional control members 103 and allowing the implementation of a servo controller for controlling the propulsion system 102 and the motorised directional control members 103.

This arrangement and its operation are known per se and will not be further detailed, in this case, except in relation to the invention itself.

More precisely, the computer program comprises a hybrid navigation module that is arranged to determine in a way known per se, on the basis of the information received from the inertial measurement unit 105 and the receiver 106, a position and an attitude of the agent k.

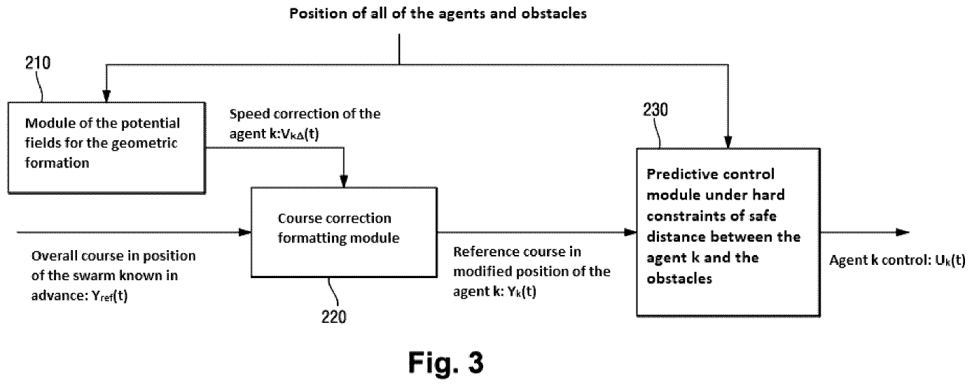

The computer program also comprises a control module arranged in order to generate the control signals intended for the propulsion system 102 and the motorised directional control members 103, in particular, on the basis of the position and the attitude provided by the navigation module and provided with a reference course previously transmitted to the computer control unit, for example by an operator. As will be further described in detail below, the control module comprises (see FIG. 3):
a potential field algorithmic module 210 for generating a speed correction;
a formatting module 220 for transforming the speed correction into a position correction;
Model Predictive Control 230 (or MPC) for course following using the position correction and a non-linear model predictive control method applying a hard avoidance constraint (in this case, the constraint is non-linear).

The computer control unit 107 is also connected to a radio signal transceiver 108 so that each agent may exchange their positions and the position of the obstacles detected by the sensors 104 with the other agents. To do this, a virtual communication bus is defined that is common to all of the agents and on which the agents emit their positions, their speeds and the positions of the obstacles which they have detected so that all of the positions of the agents and obstacles are accessible on this bus.

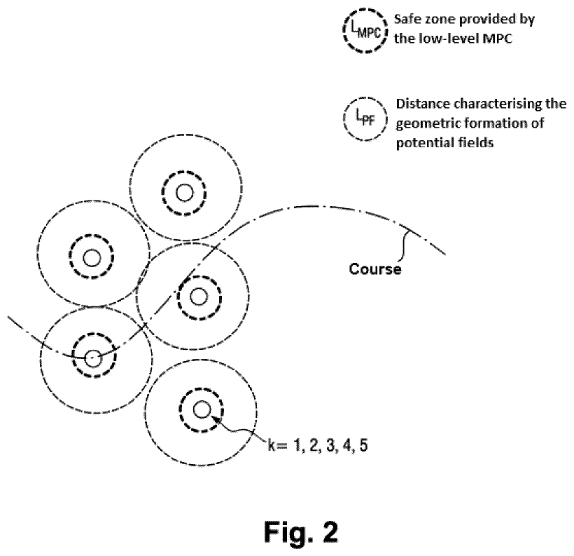

In FIG. 2, the agents are designated by the general references 1 to 5 (i.e., k=1, 2, 3, 4, 5 in FIG. 2) and each symbolised by a dot. Agents 1, 2, 3, 4, 5 are thus identical to one another in the embodiment described.

The method of the invention is described below.

The following is presented:
the swarm consists of a number Mₐ of agents;
the position of the i^{th} agent is denoted Y_{a,i}(t)=[x_{a,i}(t),y_{a,i}(t),z_{a,i}(t)], with i=1, . . . , Mₐ;
the number of obstacles to avoid is Mₒ;
the position of the j^{th} obstacle is denoted Y_{o,j}(t)=[x_{o,j}(t),y_{o,j}(t),z_{o,j}(t)], with j=1, . . . , Mₒ;
each agent k knows the position of all of the other agents and the position of all of the obstacles since their positions have been exchanged between the agents via the transceivers 108;
the swarm must follow a global reference course in position denoted Y_{ref}(t)=[x_{ref}(t),y_{ref} (t),z_{ref}(t)] that is presumed to be known in advance. This overall reference course has, for example, been transmitted to the computer control unit 107 of each agent k during a preliminary mission preparation phase or is transmitted during the flight of the agents to a pre-determined destination.

Described below is a description of the technical solution incorporated into the k^{th} agent of the swarm. Each swarm agent are supplied with strictly the same solution.

The agent k must follow the overall course of the swarm Y_{ref}(t) and the swarm must have an envelope with a pre-determined geometric shape (it is also said that the swarm flies in geometric formation).

The computer program of agent k executes the potential field algorithm module in order to ensure that the swarm retains the geometric shape while this course is being followed. To do this, the algorithm determines a speed correction in order to maintain a first minimum distance between the agent k and the agents around it and between the agent and any obstacle along the reference course.

The position information of all of the agents of the swarm and the obstacles is used by the algorithmic module of the potential fields 210 of the agent k in order to compute a reference speed correction V_{kΔ}(t) for the purpose of constructing the geometric formation.

The algorithmic module of the potential fields 210 incorporated into the agent k determines at each instant t the speed correction by taking account of the agents j and obstacles i surrounding the agent k as below:
For each agent j (j=1, . . . , Mₐ and j≠k), the result is:

$${e}_{k , j} ( t ) = {Y}_{a , k} ( t ) - {Y}_{a , j} ( t )$$

$${V}_{k , j} ( t ) = - {e}_{k , j} ( t ) ( a - {b}_{a} {e}^{\frac{{{e}_{k , j} ( t )}^{T} {e}_{k , j} ( t )}{{c}_{a}}} )$$

For each obstacle i, the result is:

$${e}_{k , j} ( t ) = {Y}_{a , k} ( t ) - {Y}_{a , i} ( t )$$

$${V}_{k , j} ( t ) = - {e}_{k , j} ( t ) ( - {b}_{o} {e}^{\frac{{{e}_{k , j} ( t )}^{T} {e}_{k , j} ( t )}{{c}_{o}}} )$$

The speed correction is thus equal to:

$${V}_{k Δ} ( t ) = {\sum }_{i} {V}_{k , i} ( t ) + {\sum }_{j} {V}_{k , j} ( t )$$

The parameters a, bₐ and cₐ express the geometrical formation in a way that is known per se. It may take various forms as a function of the values of the parameters and the inter-agent distance will asymptotically tend to be greater than a distance L_{PF} provided that:

$${c}_{a} = \frac{{L}_{PF}^{2}}{log ( \frac{{b}_{a}}{a} )}$$

The distance L_{PF} is a characteristic magnitude of the formation and is determined by the user as a function of the mission assigned to the swarm of agents. The parameters bₒ and co make it possible to specify a first required minimum distance between the agents and the obstacles. Empirically, by simulation, it can be seen that this distance will tend asymptotically to be greater than L_{PF} if, for example:

$${b}_{0} = 1 ,$$

$${c}_{o} = {c}_{a}$$

It is important to note that the geometric formation defined by the algorithmic module of the potential fields will only be achieved asymptotically, i.e., when the time t tends towards infinity (t→∞) and that nothing guarantees its transient geometric characteristics. It is said that time is infinite with regard to the slowest dynamics of the system (for example with respect to the dynamics of the guide loop of the drones).

It must be noted that, by their very nature, the principle of potential fields generates for the agent k a reference speed correction V_{kΔ}(t), however, the agent k must follow a course in position. The computer program of agent k then executes the formatting module 220 in order to:
transform the speed correction into a position correction by means of a digital integration operation;
initialise this integration to zero depending on whether the module of the potential fields is activated/deactivated;
maintain constant, the position correction over the prediction horizon of the Model Predictive Control that produces a predictive control utilised at low level for following the reference course thus modified.

The module of the potential fields is deactivated in the event that the accomplishment of the mission requires the current formation to be abandoned and/or requires a special formation that is faster to configure manually (for example, agents are placed onto a straight line in order to examine a road). In this case, only the Model Predictive Control 230 participates in controlling each agent k. Conversely, during the same mission, the module of the potential fields may be activated in the event that the accomplishment of the mission requires the formation to be adopted: hence the interest in resetting the integration.

Considering Tₑ, the sampling rate of the control, the formatting module 220 generates, by digital integration, the course correction in position for each agent k, i.e.:

$${Y}_{k Δ} ( t ) = {T}_{e} {V}_{k Δ} ( t ) + {Y}_{k Δ} ( t - 1 )$$

If the potential field algorithmic module is activated at the instant t₀, the result is Y_{kΔ}(t₀−1)=0. Agent k must therefore follow the following instantaneous reference course to ensure that the swarm will tend towards the geometric formation conferred by the potential field algorithmic module:

$${Y}_{k} ( t ) = {Y}_{ref} ( t ) - {Y}_{k Δ} ( t )$$

In order to utilise the Model Predictive Control 230 for its ability to impose constraints, the course to be followed Yₖ(t) must be known in advance at least over the prediction horizon N (that will be explained below) of the Model Predictive Control 230. However, in the expression of Yₖ(t), the course correction Y_{kΔ}(t) is not known in advance since it comes from a computation at time t. The formatting module 220 is, in this case, arranged to keep the course correction constant in position Y_{kΔ}(t) over the prediction horizon N of the Model Predictive Control 230. Thus, at each instant t, the reference that the Model Predictive Control 230 of the agent k must follow over the prediction horizon is constructed as follows:

$${Y}_{k MPC} ( t + n {T}_{e} ) = {Y}_{ref} ( t + n {T}_{e} ) - {Y}_{k Δ} ( t ) with n = 0 , … , N - 1$$

This construction may be done by filling a stack or a memory with the previous formula.

The Model Predictive Control 230 is arranged to compute a sequence of controls, future resolving a constrained optimisation problem resolved online at each sampling period. The principle implemented is to give the controlled system (the vehicle and its propulsion systems and motorised directional control members) an optimal required behaviour over a future horizon (i.e., a prediction horizon) of size N or N*Te in units of time). The behaviour is optimal in the sense of a cost function to be minimised and constraints to be satisfied. The sequence of controls sought is thus of size N.

During the optimisation process, for a given sequence of controls, the behaviour is predicted by a predictor, that is a model of the system to be controlled and that depends completely on the machine in question. To follow a course, the Model Predictive Control 230 of the agent k typically resolves the following optimisation problem online at each sampling period:

$${min}_{Δ {U}_{k}} ( {E}_{k}^{T} {QE}_{k} + Δ {U}_{k}^{T} R Δ {U}_{k} )$$

$$subject to$$

$$\begin{matrix}{E}_{k} ( n {T}_{e} ) = {Y}_{k MPC} ( t + n {T}_{e} ) - {\hat{Y}}_{k} ( n {T}_{e} ) \\ {\hat{ϕ}}_{k} ( n {T}_{e} + 1 ) = {F}_{k} ( {\hat{ϕ}}_{k} ( n {T}_{e} ) , {u}_{k} ( n {T}_{e} ) ) \\ {\hat{Y}}_{k} ( n {T}_{e} ) = {G}_{k} ( {\hat{ϕ}}_{k} ( n {T}_{e} ) , {u}_{k} ( n {T}_{e} ) ) \\ Δ {u}_{k} ( n {T}_{e} ) = {u}_{k} ( n {T}_{e} ) - {u}_{k} ( n {T}_{e} - 1 ) \\ {C}_{k} ( {\hat{Y}}_{k} ( n {T}_{e} ) , {u}_{k} ( n {T}_{e} ) ) \leq 0\end{matrix} \} n = 0 , … , N - 1$$

With Δuₖ={Δuₖ(0), Δuₖ(1), . . . , Δuₖ (N−1)}; Fk and Gk are respectively the state equation and the observation equation of the predictor (both of these equations thus depend on the type of machine). For multi-copters, the equations for the states of the agent k, expressed in the geographical reference frame NED, are:

$${F}_{k} ( {ϕ}_{k} ( \text{} {nT}_{e} ) , \text{} {u}_{k} ( \text{} {nT}_{e} ) = \text{} {T}_{e} [ \begin{matrix}{\dot{x}}_{k} ( {nT}_{e} ) \\ {\dot{y}}_{k} ( {nT}_{e} ) \\ {\dot{z}}_{k} ( {nT}_{e} ) \\ - \frac{{K}_{fx}}{{m}_{k}} {\dot{x}}_{k} ( {nT}_{e} ) - ( cos ( {φ}_{k} ( {nT}_{e} ) sin \\ ( {θ}_{k} ( {nT}_{e} ) ) cos ( {φ}_{k} ( {nT}_{e} ) ) + \\ sin ( {φ}_{k} ( {nT}_{e} ) ) sin ( {φ}_{k} ( {nT}_{e} ) ) ) \frac{{T}_{k} ( {nT}_{e} )}{{m}_{k}} \\ - \frac{{K}_{fy}}{{m}_{k}} {\dot{y}}_{k} ( {nT}_{e} ) - ( sin ( {φ}_{k} ( {nT}_{e} ) ) sin \\ ( {θ}_{k} ( {nT}_{e} ) ) cos ( {φ}_{k} ( {nT}_{e} ) ) - \\ cos ( {φ}_{k} ( {nT}_{e} ) ) sin ( {φ}_{k} ( {nT}_{e} ) ) ) \frac{{T}_{k} ( {nT}_{e} )}{{m}_{k}} \\ g - \frac{{K}_{fz}}{{m}_{k}} {\dot{z}}_{k} ( {nT}_{e} ) - cos ( {θ}_{k} ( {nT}_{e} ) ) \\ cos ( {φ}_{k} ( {nT}_{e} ) ) \frac{{T}_{k} ( {nT}_{e} )}{{m}_{k}}\end{matrix} ] + [ \begin{matrix}{x}_{k} ( {nT}_{e} ) \\ {y}_{k} ( {nT}_{e} ) \\ {z}_{k} ( {nT}_{e} ) \\ {\dot{x}}_{k} ( {nT}_{e} ) \\ {\dot{y}}_{k} ( {nT}_{e} ) \\ {\dot{z}}_{k} ( {nT}_{e} )\end{matrix} ]$$

$${G}_{k} ( {ϕ}_{k} ( {nT}_{e} ) , {u}_{k} ( {nT}_{e} ) = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] [ \begin{matrix}{x}_{k} ( {nT}_{e} ) \\ {y}_{k} ( {nT}_{e} ) \\ {z}_{k} ( {nT}_{e} ) \\ {\dot{x}}_{k} ( {nT}_{e} ) \\ {\dot{y}}_{k} ( {nT}_{e} ) \\ {\dot{z}}_{k} ( {nT}_{e} )\end{matrix} ]$$

$${ϕ}_{k} ( {nT}_{e} ) = [ \begin{matrix}{x}_{k} ( {nT}_{e} ) \\ {y}_{k} ( {nT}_{e} ) \\ {z}_{k} ( {nT}_{e} ) \\ {\dot{x}}_{k} ( {nT}_{e} ) \\ {\dot{y}}_{k} ( {nT}_{e} ) \\ {\dot{z}}_{k} ( {nT}_{e} )\end{matrix} ] , {u}_{k} ( {nT}_{e} ) = [ \begin{matrix}{T}_{k} ( {nT}_{e} ) \\ {φ}_{k} ( {nT}_{e} ) \\ {θ}_{k} ( {nT}_{e} ) \\ {φ}_{k} ( {nT}_{e} )\end{matrix} ]$$

In which:
Tₖ represents the propulsion of the drone;
φₖ, θₖ, ψₖ represent the Euler angles of the drone (absolute angular orientation);
xₖ, yₖ, zₖ represent the positions (x, y) and the altitude of the drone and \dot{x}ₖ, \dot{y}ₖ, żₖ the corresponding speeds;
mₖ represents the mass of the drone k;
K_{fx,y,z} represent the air resistance coefficients g represents zero gravity.

The predictor is defined by the following system of recurring equations:

$$\begin{matrix}{\hat{ϕ}}_{k} ( n {T}_{e} + 1 ) = {F}_{k} ( {\hat{ϕ}}_{k} ( n {T}_{e} ) , {u}_{k} ( n {T}_{e} ) ) \\ {\hat{Y}}_{k} ( n {T}_{e} ) = {G}_{k} ( {\hat{ϕ}}_{k} ( n {T}_{e} ) , {u}_{k} ( n {T}_{e} ) )\end{matrix} \}$$

The predictor depends completely on the agent k and its type (drone, aircraft, car, etc.). The prediction is initiated by a measurement of the state of the system \hat{φ}ₖ(0)=φₖ(t) possibly given by a state observer if the state of the machine is not completely measured by sensors. Eₖ represents the predicted error in following the course of the agent k. uₖ represents the control of the agent k.

At each instant t, resolving this optimisation problem leads to the optimal sequence:

$$Δ {U}_{k}^{*} = \{ Δ {u}_{k}^{*} ( 0 ) , Δ {u}_{k}^{*} ( 1 ) , … , Δ {u}_{k}^{*} ( N - 1 ) \}$$

Since it is not possible to apply the entire optimal control sequence to the system (because there is no access to the future of the physical system!), in reality, the first value of the control sequence is applied. This is the principle of the receding horizon. The control applied to the agent k is recorded at the instant t:

$${u}_{k} ( t ) = Δ {u}_{k}^{*} ( 0 ) + {u}_{k} ( t - n {T}_{e} )$$

The function Cₖ(\hat{X}ₖ(nTₑ),uₖ (nTₑ)) expresses all of the constraints which the prediction of the controlled system must satisfy. The receding horizon principle presumes that if the prediction satisfies the constraints, then, step by step, the controlled real physical system will also satisfy these constraints if the predictor and the real system are not too different.

The potential fields are then secured by requiring the agent k to be located at a second minimum distance L_{MPC} from the other agents and obstacles. This is mathematically expressed as:

$$\vert {\hat{Y}}_{k} ( n {T}_{e} ) - {Y}_{a , i} \vert \geq {L}_{MPC} , n = 0 , … , N - 1 ; i = 1 , … , {M}_{a} ; i \neq k$$

$$\vert {\hat{Y}}_{k} ( n {T}_{e} ) - {Y}_{o , j} \vert \geq {L}_{MPC} , n = 0 , … , N - 1 ; j = 1 , … , {M}_{o}$$

Thus, the potential field becomes safe if si L_{MPC}<L_{PF}.

It is therefore the low-level avoidance constraints of the predictive control, set on safety distances prohibited from being crossed and smaller than the distances characteristic of the geometric formation of the potential fields (thus L_{MPC}<L_{PF}), which guarantee the safety of the potential field.

When the avoidance constraints of the predictive module are inactive, there is a conventional potential field. When the constraints of the predictive stage are activated (as a function of the distance separating the agent k and the other agents and the agent k and the obstacles compared with a threshold, in this case, the threshold L_{MPC}), the latter guarantees non-collision while minimising the error in following the course, that is to say by degrading as little as possible, when the constraints of the predictive stage are activated, the geometric formation defined by the implementation of the potential field algorithm. Thus, the modular aspect is retained, i.e., the mathematical characteristics of the geometric formation when the constraints are inactive are retained and the latter are degraded as little as possible. It is modularity in the mathematical sense: two functions are modular if they may be executed independently of one another (one is executed but not the other) or dependent on one another (the output of one is the input of the other). The constraints being activated for the minimum time necessary, retain as much as possible the characteristics of the geometric formation provided by the potential field algorithmic module.

Advantageously, in this case, the Model Predictive Control 230 is arranged to add other constraints.

Among these, provision may be made for a constraint on the instantaneous power consumption of the agent, for example. In this case, this amounts to completing the constraint:

$${{u}_{k} ( n {T}_{e} )}^{2} \leq {P}_{max} , n = 0 , … , N - 1$$

Alternatively or additionally, it is possible to provide a constraint on the average power (that expresses a type of running time):

$$\frac{1}{{T}_{e}} {\sum }_{n = 0 …N - 1} {{u}_{k} ( n {T}_{e} )}^{2} \leq {\overline{P}}_{max}$$

During the securing manoeuvres, it is also possible to constrain certain magnitudes representative of a load factor of the agent k (such as the speed or acceleration) and to force them to remain within a range of values. For example, a constraint is set on the speed of the agent in order to protect the agent in terms of load factor, and also in order to prevent it from stalling (in the case of an aircraft):

$${V}_{min} \leq \frac{{\hat{Y}}_{k} ( ( n + 1 ) {T}_{e} ) - {\hat{Y}}_{k} ( n {T}_{e} )}{{T}_{e}} \leq {V}_{max} , n = 0 , … , N - 1$$

This is possible because of the use of a constrained non-linear Model Predictive Control for course following.

Naturally, the invention is not limited to the embodiment described, but covers any variant included within the scope of the invention as defined by the claims.

In particular, the agents k may have a structure that is different from that shown in FIG. 1.

The term “propulsion system” is used to mean any drive unit designed to move a vehicle. In the case of multi-copter vehicles, the term motorisation relates to power and drive systems which provide both propulsion and lift.

The term “motorised directional control member” is used to mean any element that may be controlled to guide any vehicle.

The obstacle sensors may use technologies other than those mentioned and, for example, comprise optical means (imagers) or ultrasonic means (sonars).

Transceivers do not need to be used for exchanging positions of obstacles and agents, each agent relying solely on its obstacle sensors.

The exchange of positions may be limited to neighbouring agents, i.e., part of the group, as a function of the range of transceivers, multi-cast and non-broadcast communication, etc.

The speed correction may be determined by using an algorithm other than the potential field algorithm and, for example, by reinforcement learning.

Within the formatting module 220, strategies other than maintaining the correction in position over the prediction horizon may be envisaged:
linear interpolation in the event that a measurement of the speed of the agents is available;
use of more or less complex agent models (kinematic model, neural network, etc.) in order to predict the position correction on the horizon.

The geometrical configuration may be fixed for the entire course or evolve as a function of the environment.

The invention may be applicable to any type of vehicle:
piloted or not;
inhabited or not;
carrying passengers and/or a load;
terrestrial, aquatic, aerial or space . . .

1. A method of controlling at least one vehicle comprising a propulsion system, motorised directional control members and a computer control unit connected to the motorised directional control members in order to control said members and guide the vehicle along a reference course, comprising:
determining a speed correction in order to maintain a first minimum distance between the vehicle and any obstacle along the reference course;
transforming the speed correction into a position correction and estimating the position correction over a prediction horizon to determine a course to be followed over the prediction horizon;
determining controls to be applied to the propulsion system and to the motorised directional control members over the prediction horizon in order to follow the course to be followed by applying an avoidance constraint corresponding to a second minimum distance between the vehicle and any obstacle along the course to be followed over the prediction horizon, the second minimum distance being less than the first minimum distance and the avoidance constraint being applied when it is predicted that the vehicle and the obstacle are separated by a distance less than the second minimum distance.

2. The method according to claim 1, wherein the speed correction is determined by using a potential field algorithm.

3. The method according to claim 1, wherein the controls are determined by using a constrained non-linear predictive model.

4. The method according to claim 3, wherein the controls over the prediction horizon for following the course to be followed are determined by also applying at least one operating constraint relating to at least one of the following operating parameters: instantaneous power consumed by the vehicle, average power consumed by the vehicle, load factor, vehicle speed, vehicle acceleration, etc.

5. The method according to claim 1, applied to a plurality of vehicles moving in a group, wherein vehicles moving in the vicinity of any determined vehicle constitute as many obstacles for said determined vehicle.

6. The method according to claim 5, wherein at least those of the vehicles moving in the vicinity of to one another communicate their positions with one another.

7. The method according to claim 5, wherein each vehicle comprises an obstacle detector and at least those of the vehicles moving in the vicinity of one another communicate with one another at least one position of an obstacle that they have detected.

8. The method according to claim 5, wherein the speed correction is determined to maintain a pre-determined geometric configuration of the vehicles as they move along the reference course.

9. The method according to claim 1, wherein the position correction over the prediction horizon is estimated:
by considering the constant position correction over the prediction horizon; and/or
by linear interpolation on the basis of measured velocities; and/or
by a vehicle model.

10. The vehicle comprising a propulsion system, motorised directional control members and a computer control unit connected to the motorised directional control members and arranged in order to control said members by applying the method in accordance with claim 1.
